(19) United States
(12) Patent Application Publication
(10) Pub. No.: US 2026/0048848 A1
(43) Pub. Date: Feb. 19, 2026

(54) LOCK MECHANISM FOR TELESCOPIC HOLD OPEN ROD

(71) Applicant: Rohr, Inc., Chula Vista, CA (US)

(72) Inventors: Divya Prakash, Bangalore (IN); Sanjay Venugopal, Hassan (IN); Vijayan Ramachandran, Bangalore (IN); Braskel Phillips, San Diego, CA (US); Mahesha Lakkappakodi, Bangalore (IN); Imad Ghandour, San Diego, CA (US); Jayvin Mistry, Bonita, CA (US)

(21) Appl. No.: 19/298,785

(22) Filed: Aug. 13, 2025

(30) Foreign Application Priority Data
Aug. 13, 2024 (IN) 202411061560

(51) Int. Cl. B64D 29/08

(52) U.S. Cl. CPC B64D 29/08

(57) ABSTRACT

A hold open rod has a lock sleeve, an outer cylinder, a lock mechanism, a plurality of lock balls, a retention sleeve, a piston including a piston head, a release spring, and a lock spring. The hold open rod is configured to move between an unlocked configuration (e.g., stowed) to a locked and loaded configuration. Relative movement (e.g., axially and/or radially) of components in the hold open rod assembly enable both configurations. The lock mechanism is positioned with the lock sleeve and the outer cylinder, and mechanically engages the piston head. The pin is positioned with the lock sleeve and a guide slot in the outer cylinder. The plurality of lock balls engage the lock sleeve, outer cylinder, and retention sleeve.

This application claims priority to Indian Patent Appln. No. 202411061560 filed Aug. 13, 2024, which is hereby incorporated herein by reference in its entirety.

### BACKGROUND OF THE INVENTION

### 1. Technical Field

The present disclosure relates to hold open rods in general and to self lock mechanisms for telescoping hold open rods in particular.

### 2. Background Information

A nacelle often includes a pair of fan cowls, with one of the fan cowls disposed on a first side of the engine (e.g., the “inner fan cowl”) and the other fan cowl disposed on a second side of the engine opposite the first side (e.g., the “outer fan cowl”). The top end of the fan cowls are typically hinged to the pylon or to a frame structure at the top of the nacelle and the bottom end of the fan cowls may be joined together with one or more latch mechanisms. Each fan cowl may be pivoted outwardly to provide access to engine and nacelles components; e.g., for inspection and/or maintenance of components enclosed within the fan cowl.

Hold open rods (HORs) may be used to hold a fan cowl in an open position. In some applications, a fan cowl HOR may support a considerable amount of weight. It is important that a HOR not only be able to support the fan cowl weight, but also be configured for safe operation. For example, a fan cowl HOR is preferably configured to lock in a deployed configuration when the fan cowl is open, and is configured to prevent inadvertent closing.

### SUMMARY

According to an aspect of the present disclosure a hold open rod (HOR) includes an axial centerline that extends between a hold open rod first axial end and a hold open rod second axial end. The hold open rod includes a lock sleeve (LS), a pin, an outer cylinder, a retention sleeve, a piston, a plurality of lock balls, a release spring, a lock mechanism, and a lock spring. The LS includes a first axial end and a second axial end generally opposite to the first axial end, a LS outer radial surface and a LS inner radial surface, the LS inner radial surface defining a first LS cavity section and a second LS cavity section, the LS including a slot extending through the LS outer radial surface and the LS inner radial surface, and the LS including a LS channel. The pin includes a pin length (PL), where the pin engaged with the slot and extending radially inward from the LS inner radial surface. The outer cylinder (OC) includes an OC outer radial surface, an OC inner radial surface defining an OC inner cavity, a plurality of lock ball apertures extending between the OC outer radial surface and the OC inner radial surface, and a pin guide slot configured to receive a portion of the pin. The outer cylinder extends axially within the first LS cavity section and the second LS cavity section. The retention sleeve (RS) includes a RS first axial end and a RS second axial end, a first RS outer radial surface, a RS channel, a second RS outer radial surface, a RS first end surface, a RS second end surface, and an RS inner radial surface defining a RS bore, The RS is disposed within the OC inner cavity. The piston includes a piston outer radial surface and a piston head (PH), the piston head having a PH outer radial surface coaxial with the piston outer radial surface. The piston and the piston head are disposed within OC inner cavity. The plurality of lock balls are each configured to pass through a respective lock ball aperture. The release spring is disposed between the OC outer radial surface and the LS inner radial surface. The lock mechanism includes an actuation link and a lock segment. The actuation link includes a first link end and a second link end generally opposite the first link end, a first link surface adjacent a sloped surface, the sloped surface is adjacent a second link surface, the first link surface is offset from the second link surface, the actuation link having a pivot point, the actuation link having a pair of extensions defining a channel therebetween. The lock segment includes a first lock end and a second lock end generally opposite the first lock end, and a central protrusion between the first lock end and the second lock end that engages the channel. The release spring is disposed between the OC outer radial surface and the LS inner radial surface. The lock spring is disposed between the OC inner radial surface and the piston outer radial surface.

In any of the aspects or embodiments described above or herein, the hold open rod may be configurable in an unlocked configuration and the locked configuration. In the unlocked configuration, each respective one of the plurality of lock balls may extend within each respective one of the plurality of lock ball apertures and the LS channel.

In the locked configuration, each respective one of the plurality of lock balls extends within each respective one of the plurality of lock ball apertures and the RS channel.

In any of the aspects or embodiments described above or herein, the RS channel may extend between the first RS outer radial surface and the second RS outer radial surface. The RS channel may include a RS base surface disposed between a pair of RS ramp surfaces.

In any of the aspects or embodiments described above or herein, the LS channel may extend around a circumference of the first LS cavity section. The LS channel may include a base surface disposed between a pair of LS ramp surfaces.

In any of the aspects or embodiments described above or herein, the hold open rod, when in a transition from the unlocked configuration to the locked configuration, may include the lock sleeve in a configuration where the lock sleeve may translate axially relative to the outer cylinder in a direction toward the first axial end. The lock sleeve may also be configured when transitioning from the unlocked configuration to the locked configuration such that one of the LS ramp surfaces pushes each respective lock ball radially inward.

In any of the aspects or embodiments described above or herein, the hold open rod, when in the locked configuration, may include each respective lock ball extending within a respective said lock ball aperture and the RS channel.

In any of the aspects or embodiments described above or herein, the RS channel may extend between the first RS outer radial surface and the second RS outer radial surface, and includes a RS base surface disposed between a pair of RS ramp surfaces.

In any of the aspects or embodiments described above or herein, the hold open rod, when in a transition from the locked configuration to the unlocked configuration, may include lock sleeve in a configuration where the lock sleeve may translate downwardly towards the second axial end causing a detent extending radially inwardly from the LS inner radial surface to translate from the first link end to the second link end. Such movement by the lock sleeve may include pivoting the lock segment radially outward of the OC inner radial surface. Such movement by the lock sleeve may include aligning the LS channel with the plurality of lock ball apertures and the RS channel causing one of the RS ramp surfaces to push each respective lock ball radially outward from the RS channel through the respective lock ball aperture and into the respective LS channel. The piston head may be configured to translate axially relative to the outer cylinder in a direction toward the second axial end bypassing the lock segment.

In any of the aspects or embodiments described above or herein, the piston head may include a bearing disposed in a PH channel disposed on the PH outer radial surface.

In any of the aspects or embodiments described above or herein, the pin guide slot may be configured such that a transition from the locked configuration to the unlocked configuration requires the lock sleeve to be translated both axially and rotationally relative to the outer cylinder.

In any of the aspects or embodiments described above or herein, the pin guide slot may include a first axial end, an intermediate position a second axial end. The pin guide slot may be configured such that the first axial end is aligned axially with the intermediate position. The pin guide slot may be configured such that intermediate position is aligned radially with the second axial end.

In any of the aspects or embodiments described above or herein, the release spring may be configured such that the release spring is axially disposed between an OC shoulder and a release spring flange that may extend outwardly from the outer cylinder.

In any of the aspects or embodiments described above or herein, the hold open rod may be configurable in an unlocked configuration and a locked configuration such that when the hold open rod is in the locked configuration, a second RS end surface may be disposed contiguous with the piston head.

In any of the aspects or embodiments described above or herein, the hold open rod may be configurable in a locked and loaded configuration. In the locked and loaded configuration, the lock segment may be configured such that it is radially inward of the OC inner radial surface.

In any of the aspects or embodiments described above or herein, the outer cylinder may include a release spring flange extending radially outward from the OC outer radial surface. The lock sleeve may includes a LS shoulder surface extending between a first LS inner radial surface and a second LS inner radial surface. The release spring may be configured such that it is axially disposed between the release spring flange and the LS shoulder surface.

In any of the aspects or embodiments described above or herein, the hold open rod may be configured such that during a first transition from the unlocked configuration to the locked configuration, the piston head may be configured to translate axially relative to the outer cylinder towards the hold open rod first axial end until the piston head engages the RS second axial end. The piston head may be configured such that as the piston head engages the RS second axial end, the piston head may compress the lock spring until the RS channel is aligned with the plurality of lock ball apertures. The lock sleeve may be configured such that it translates axially and rotationally relative to the outer cylinder. The lock sleeve may be configured such that when it translates axially and rotationally relative to the outer cylinder, each respective one of the plurality of lock balls may move radially inward to extend within each respective one of said plurality of lock ball aperture and the first RS channel.

In any of the aspects or embodiments described above or herein, the hold open rod may be configured such that when the hold open rod is in a second transition from the locked configuration to the unlocked configuration, the lock sleeve may be configured to translate rotationally and axially relative to the outer cylinder. The hold open rod may be configured such that the axial translation is in a direction toward the hold open rod second axial end until the LS channel is aligned with the lock ball apertures. The hold open rod may be configured such that during axial translation towards the hold open rod second axial end, each respective lock ball may move radially outward to extend within the respective said lock ball aperture and the LS channel. The piston head may be configured to translate axially relative to the outer cylinder in a direction toward the second axial end.

In any of the aspects or embodiments described above or herein, or in a separate embodiment, a hold open rod includes an axial centerline that extends between a hold open rod first axial end and a hold open rod second axial end. The hold open rod includes a lock sleeve, an outer cylinder, a retention sleeve, a piston, a lock mechanism, a release spring, and a lock spring. The lock sleeve (LS) includes a first axial end and a second axial end generally opposite to the first axial end, a LS outer radial surface and an LS inner radial surface, where the LS inner radial surface defining a first LS cavity section and a second LS cavity section. The outer cylinder (OC) includes an OC outer radial surface, an OC inner radial surface defining an OC inner cavity. The retention sleeve (RS) includes a RS first axial end and a RS second axial end, a first RS outer radial surface, a RS first end surface, a RS second end surface, and an RS inner radial surface defining a RS bore. The RS is disposed within the OC inner cavity. The piston includes a piston outer radial surface and a piston head (PH). The piston head includes a PH outer radial surface coaxial with the piston outer radial surface. The piston and the piston head are disposed within OC inner cavity. The lock mechanism includes an actuation link and a lock segment. The actuation link includes a first link end and a second link end generally opposite the first link end, a first link surface adjacent a sloped surface, the sloped surface is adjacent a second link surface, the first link surface is offset from the second link surface, the actuation link includes a pivot point, the actuation link includes a pair of extensions defining a channel therebetween. The lock segment includes a first lock end and a second lock end generally opposite the first lock end, a central protrusion between the first lock end and the second lock end that engages the channel. The release spring is disposed between the OC outer radial surface and the LS inner radial surface. The lock spring is disposed between the OC inner radial surface and the piston outer radial surface.

In any of the aspects or embodiments described above or herein, or in a separate embodiment, a hold open rod includes an axial centerline that extends between a hold open rod first axial end and a hold open rod second axial end. The hold open rod includes a lock sleeve, an outer cylinder, a retention sleeve, a piston, a plurality of lock balls, a release spring, and a lock spring. The lock sleeve (LS) includes a first axial end and a second axial end generally opposite to the first axial end, a LS outer radial surface and a LS inner radial surface, the LS inner radial surface defining a first LS cavity section and a second LS cavity section, where the LS having a LS channel. The outer cylinder (OC) includes an OC outer radial surface, an OC inner radial surface defining an OC inner cavity, and a plurality of lock ball apertures extending between the OC outer radial surface and the OC inner radial surface. The outer cylinder extends axially within the first LS cavity section and the second LS cavity section. The retention sleeve (RS) includes a RS first axial end and a RS second axial end, a first RS outer radial surface, a RS channel, a second RS outer radial surface, a RS first end surface, a RS second end surface, and an RS inner radial surface defining a RS bore. The RS is disposed within the OC inner cavity. The piston includes a piston outer radial surface and a piston head (PH), the piston head having a PH outer radial surface coaxial with the piston outer radial surface. The piston and the piston head are disposed within OC inner cavity. The plurality of lock balls are each configured to pass through a respective lock ball aperture. The release spring is disposed between the OC outer radial surface and the LS inner radial surface. The release spring is disposed between the OC outer radial surface and the LS inner radial surface. The lock spring disposed between the OC inner radial surface and the piston outer radial surface.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a perspective view of an aircraft in accordance with various embodiments of the present disclosure.

FIG. 2 is a diagrammatic illustration of an aircraft nacelle that may include embodiments of the present disclosure.

FIGS. 3-3B are diagrammatic representations of a nacelle having a fan cowl member supported by a hold open rod (HOR) configuration. FIG. 3 illustrates the fan cowl member disposed in a stowed condition. FIG. 3A illustrates the fan cowl member disposed in a partially open condition. FIG. 3B illustrates the fan cowl member disposed in a maximum open condition.

FIG. 4 diagrammatically illustrates a present disclosure HOR embodiment in an unlocked configuration.

FIG. 5 diagrammatically illustrates a piston and piston head of a present disclosure HOR embodiment.

FIG. 6 diagrammatically illustrates an outer cylinder of a present disclosure HOR embodiment.

FIG. 7 diagrammatically illustrates a pin guide slot of a present disclosure HOR embodiment.

FIG. 8 diagrammatically illustrates a portion of a present disclosure HOR embodiment, enlarged to show a pin slot guide.

FIG. 9 diagrammatically illustrates a pin slot guide.

FIG. 10A diagrammatically illustrates an unlocked indicator.

FIG. 10B diagrammatically illustrates a locked indicator.

FIG. 11 diagrammatically illustrates a portion of a present disclosure HOR embodiment.

FIG. 12 diagrammatically illustrates a lock sleeve component of a present disclosure HOR embodiment.

FIG. 13 diagrammatically illustrates a portion of a present disclosure HOR embodiment, enlarged to show a lock mechanism.

FIG. 14 diagrammatically illustrates a portion of a present disclosure HOR embodiment, enlarged to show a lock mechanism.

FIG. 15 diagrammatically illustrates the present disclosure HOR embodiment in a locked configuration.

FIG. 16 diagrammatically illustrates the present disclosure HOR embodiment in a locked and loaded configuration.

### DETAILED DESCRIPTION

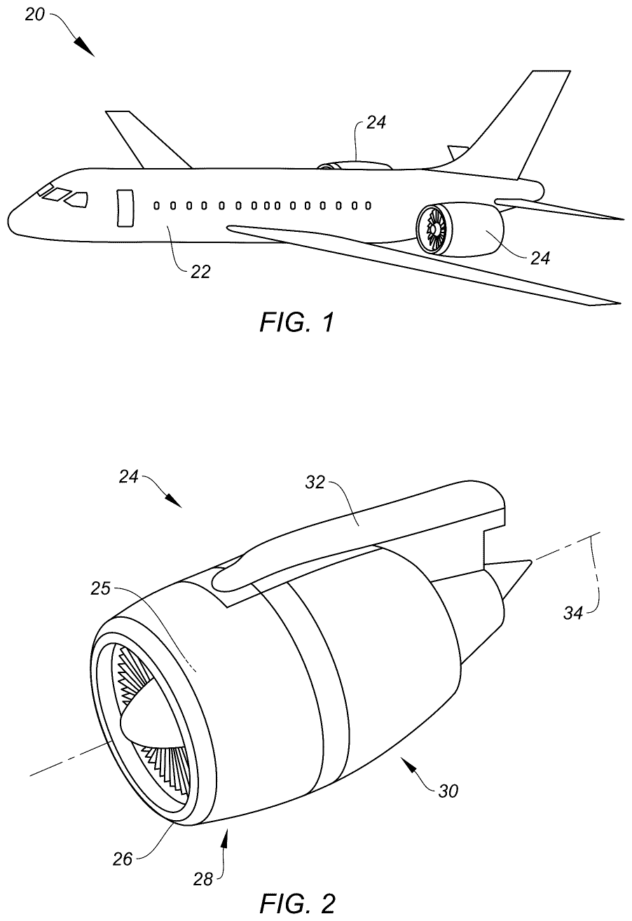

Aspects of the present disclosure include telescopic hold open rods (HORS) 36 that may be used in an aircraft cowl (e.g., fan cowl) or other movable panels (e.g., thrust reverser), an aircraft cowl 28 that utilizes the present disclosure HOR 36, and an aircraft 20 that utilizes the present disclosure system. FIG. 1 illustrates a conventional fixed wing aircraft 20 that may utilize embodiments of the present disclosure HOR 36. The aircraft 20 includes a fuselage 22 and at least one nacelle 24.

Referring to FIG. 2, a nonlimiting example of a nacelle 24 for an aircraft engine (e.g., a gas turbine engine) 25 is shown. The nacelle 24 includes an inlet 26, a cowl 28, and a thrust reverser 30. The nacelle 24 may be attached to a pylon 32 that mounts the nacelle 24 to an aircraft wing or aircraft body. The nacelle 24 surrounds the engine providing smooth aerodynamic surfaces for airflow around and into the engine.

The cowl 28 may include a first fan cowl member (e.g., an inner fan cowl) and a second fan cowl member (e.g., an outer fan cowl). The cowl 28 may also include a forward cowl and an aft cowl with respect to axial centerline 34, and/or an inner cowl positioned radially inward of an outer cowl [that is radially outward] with respect to the axial centerline 34. The first and second fan cowl members may be pivotally attached (e.g., hinged) to the pylon 32 or to a frame structure attached at the gravitational top [when the aircraft is stationary on terra firma] of nacelle 24. The nacelle 24 is disposed about an axial centerline 34 that typically coincides with the axis of rotation of an engine (e.g., gas turbine engine) housed within the nacelle 24.

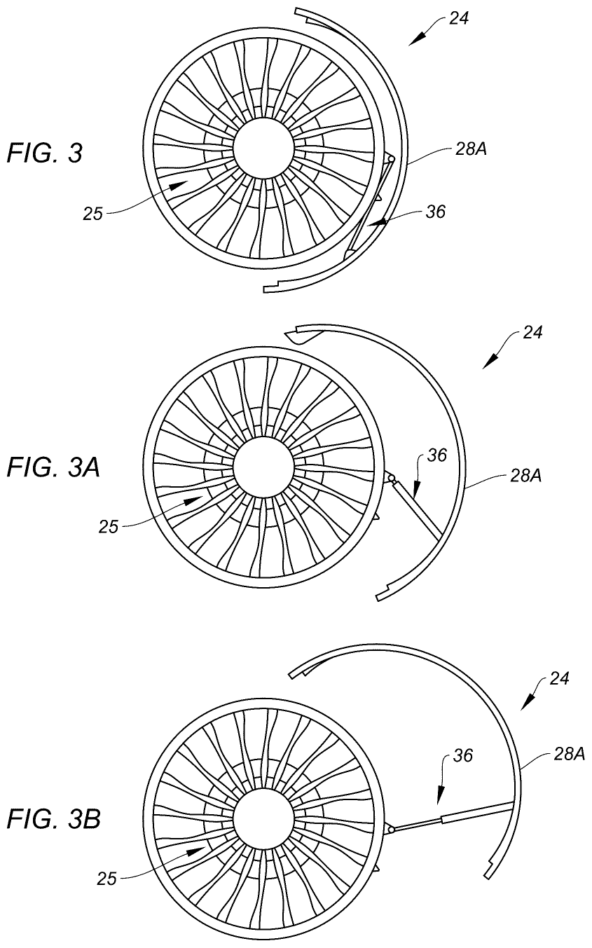

In embodiments including two cowls (e.g., a first or inner fan cowl, and a second or outer fan cowl) 28, each of the first and second fan cowl members may be movable (e.g., pivoted) between open positions (provides access into the interior of the nacelle; e.g., access to the oil tank, full authority digital engine control (FADEC), and other components) (see e.g., FIG. 3B) and a closed position (see, e.g., FIG. 3) where no interior access is permitted and the first and second fan cowl members are positioned as part of the aerodynamic shape of the nacelle 24 exterior.

Referring to FIGS. 3-3B, a portion of a nacelle 24 is diagrammatically shown. FIG. 3 illustrates a fan cowl member 28A disposed in a stowed condition with a HOR 36 pivotally connected at one end (e.g., the “nacelle end”) 56 to a fixed member of the nacelle 24 and pivotally connected at the opposite end (e.g., the “cowl end”) 54 to the fan cowl member 28A. FIG. 3A illustrates the fan cowl member 28A disposed in a partially open condition with the HOR 36 rotated from its stowed position. FIG. 3B illustrates the fan cowl member 28A disposed in a maximum open condition with the HOR 36 rotated from its stowed position and in an extended and locked (or locked and loaded) condition.

One or more latch assemblies (not shown) may be used to secure the cowl (e.g., the first and/or second fan cowl members) 28 in the closed position and provide the mechanism for selectively releasing the cowl (e.g., first and second fan cowl members) 28 from the closed position so they may be moved (e.g., pivoted, rotated, etc.) into an open position.

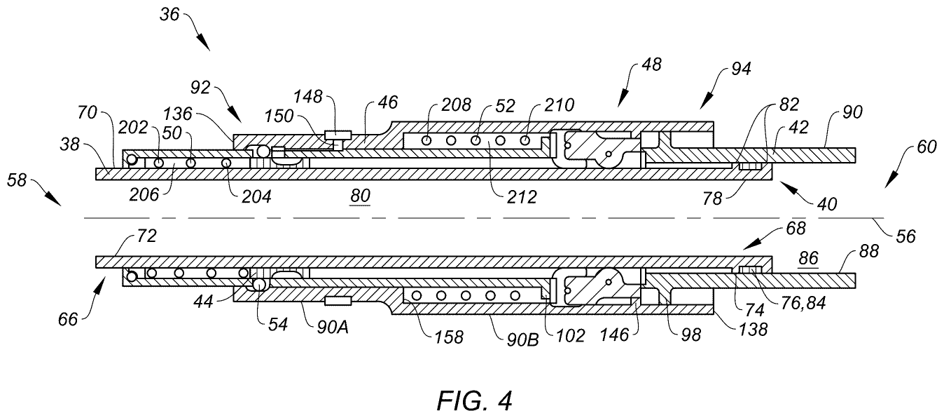

Referring to FIG. 4, the HOR 36 according to an embodiment of the present disclosure includes a piston 38, a piston head 40, an outer cylinder 42, a retention sleeve 44, a lock sleeve 46, a lock mechanism 48, a lock spring 50, a release spring 52, and a plurality of lock balls 54. The HOR 36 extends lengthwise along an axial centerline 56 between an HOR first axial end 58 (e.g., the “cowl end”) and opposite an HOR second axial end 60 (e.g., the “nacelle end”).

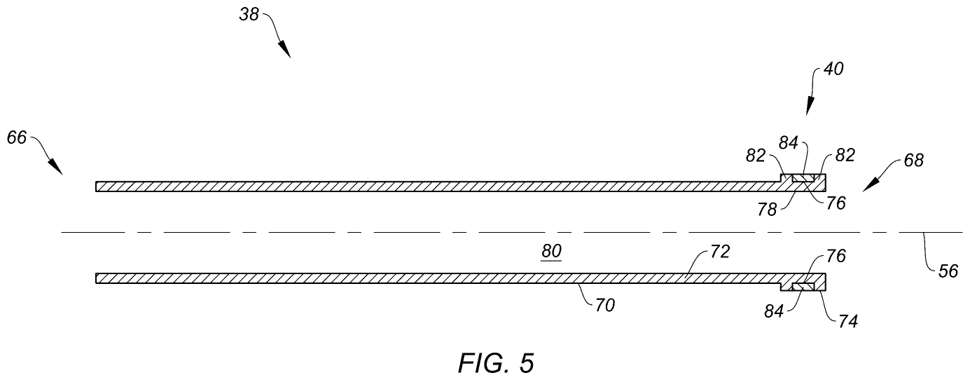

Referring to FIGS. 4 and 5, the piston 38 includes a piston first axial end 66, and a piston second axial end 68. The piston 38 includes an outer surface 70 and an inner surface 72. In some embodiments, the piston 38 includes multiple sections (or segments) that telescope (e.g., telescopically engage) with adjacent sections. The piston second axial end 68 includes the piston head 40 as discussed in greater detail below.

The piston head 40 includes a PH outer surface 74 (e.g., a PH outer radial surface), a PH channel 76 disposed in the PH outer surface 74, a PH inner surface 78 coaxial with the piston inner surface 72 that defines a piston bore 80. The PH channel 76 is defined by a lip 82 on either end of the channel 76. In some embodiments, the PH channel 76 is outward of the PH outer surface 74 adjacent to the lip 82. In some embodiments, the lip 82 projects outward from (e.g., radially outward from) the PH outer surface 74. The PH channel 76 extends around the circumference of the piston head 40. The PH channel 76 is configured to receive a bearing 84.

In some embodiments, the piston 38 is unitary with the piston head 40. In some embodiments, the piston 38 and piston head 40 are attached by chemical bonding and/or mechanical features. The piston 38 engages and/or cooperates with the piston head 40 such that the piston head 40 travels with the piston 38 during movement of the piston 38 in a first axial direction (i.e., during HOR 36 expansion). In some embodiments, the piston 38 (e.g., including one or more sections) and the piston head 40 are in mechanical communication and permit relative movement between the piston 38 and the piston head 40 in a second axial direction, opposite the first axial direction (i.e., during HOR 36 contraction or retraction).

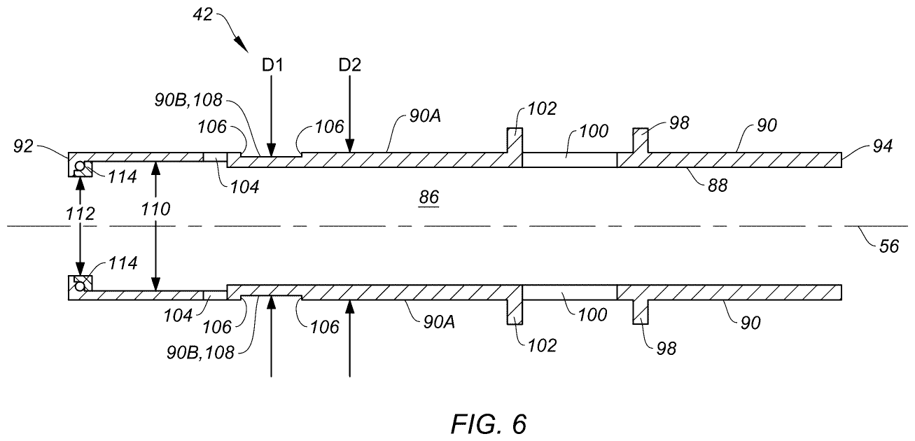

Referring to FIGS. 4 and 6, the outer cylinder 42 (OC) includes an OC inner cavity 86, an OC inner radial surface 88, an OC outer radial surface 90, an OC first axial end 92, an OC second axial end 94, an OC first axial end wall 96, a lock mechanism flange 98, at least one lock mechanism opening 100, a release spring flange 102, a plurality lock ball apertures 104, at least one OC shoulder 106, and a guide slot 108. The OC inner cavity 86 is defined by the OC inner radial surface 88. The OC outer radial surface 90 is generally opposite the OC inner radial surface 88. The OC first axial end wall 96 is disposed at the OC first axial end 92 and includes an OC first axial end wall bore 110 configured to receive a portion of the retention sleeve 44.

In some embodiments, the OC 42 may include a circumferentially extending OC retainer bore 112 disposed inwardly at the edge of the OC first axial end wall bore 110. The OC retainer bore 112 is configured to receive an OC retainer 114 as will be detailed herein. In some embodiments, the outer cylinder 42 may include an OC retainer 114 radially inward of the OC outer radial surface 90. In some embodiments, the OC 42 may include an OC retainer 114 at least partially radially outward of the OC inner radial surface 88. In some embodiments, the OC 42 may include an OC retainer 114 at least partially radially inward of the OC inner radial surface 88. The OC retainer 114 is configured for engagement with the OC retainer bore 112 disposed in the lock sleeve 46 as will be described herein.

The lock mechanism flange 98 extends from (e.g., radially outward of) the OC outer radial surface 90. The release spring flange 102 extends from (e.g., radially outward of) the OC outer radial surface 90. At least one lock mechanism opening 100 extends radially through the OC outer radial surface 90 and the OC inner radial surface 88. The at least one lock mechanism opening 100 extends axially between the lock mechanism flange 98 and the release spring flange 102. In some embodiments, the at least one lock mechanism opening 100 includes a plurality of lock mechanism openings 100, disposed radially about the OC 42, or said differently, about the circumference of the OC 42. Each of the at least one lock mechanism opening 100 is sized and configured to receive the footprint of a respective lock mechanism 48 as described in greater detail below.

The plurality of lock ball apertures 104 are aligned with one another at an axial position, are disposed around the circumference of the outer cylinder 42, and each is configured to permit a respective one of the plurality of lock balls 54 to travel radially therethrough.

The OC shoulder 106 demarcates a first OC outer radial surface 90A and a second OC outer radial surface 90B. The first OC outer radial surface 90A includes a first OC outer diameter (D1). The second OC outer radial surface 96B includes a second OC outer diameter (D2). In some embodiments, D1 is less than D2 (e.g., D1<D2). In some embodiments, a pair of OC shoulders 106 define the pin guide slot 108 as discussed in greater detail below.

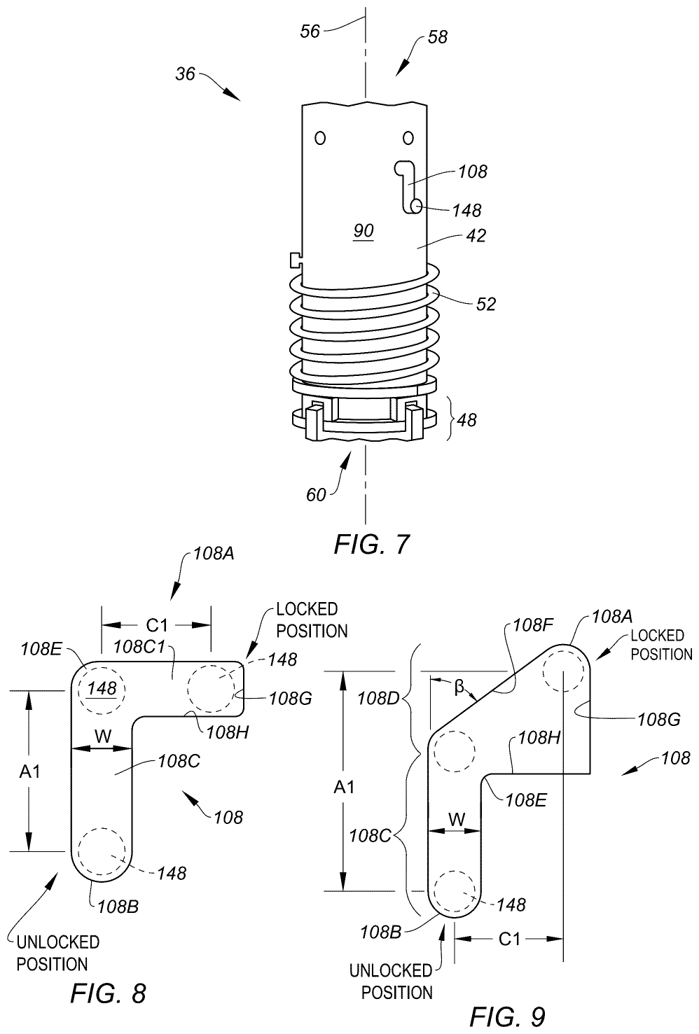

Referring to FIGS. 7-9, the pin guide slot (“PG”) 108 is configured to have a PG first axial end 108A, a PG second axial end 108B, an axially extending guide portion 108C, and an intermediate position 108E. In some embodiments, the guide slot 108 is generally “L” shaped, including variants oriented differently (e.g., upside-down). In other embodiments, the guide slot includes other shapes such as a “P”, “d”, etc. In some embodiments, a ramp portion 108D is between the guide portion 108C and the intermediate position 108E. The PG first and second axial ends 108A, 108B are axially separated from one another by a distance “A1”. The PG first and second axial ends 108A, 108B are circumferentially spaced apart from one another by a distance “C1”. The intermediate position 108E is disposed at the interface between the axially extending guide portion 108C (and in some embodiments, the ramp portion 108D) and radially extending guide portion C1. The axially extending guide portion 108C extends from the PG second axial end 108B to the intermediate position 108E. The axially extending guide portion 108C has a width “W” that is sized to form a slide fit with a pin 148 attached to the lock sleeve 46 as will be detailed herein. In embodiments including the ramp portion 108D, ramp portion 108D is defined by a guide ramp surface 108F, a side surface 108G, and a base surface 108H. Collectively [in embodiments with a ramp portion 108D, the guide ramp surface 108F, side surface 108G, and base surface 108H form a generally triangular aperture in the outer cylinder 42. The guide ramp surface 108F intersects with the axially extending guide portion 108C at the intermediate position 108E and extends to the PG first axial end 108A. The guide ramp surface 108F extends both axially and circumferentially and may be described as extending at an angle beta (β) relative to the axial centerline of the HOR 36. The side surface 108G is disposed opposite the guide ramp surface 108F, and extends from the PG first axial end 108A to the base surface 108H in a direction that is parallel to the axial centerline of the HOR 36. The base surface 108H, which is disposed proximate to the intermediate position 108E, extends circumferentially from the side surface 108G to the axially extending guide portion 108C. As will be detailed herein, the pin guide slot 108 is configured to require movement in two directions (axial and rotational) to permit the HOR 36 to transition from an unlocked configuration to a locked configuration and vice versa. The above described pin guide slot 108 configuration is an example of a configuration that requires movement in two directions (axial and rotational) to permit the HOR 36 to transition from an unlocked configuration to a locked configuration and vice versa. The present disclosure is not limited to this specific pin guide slot 108 configuration. For example, alternative pin guide slot 108 configurations may be used to satisfy a different unlock sequence.

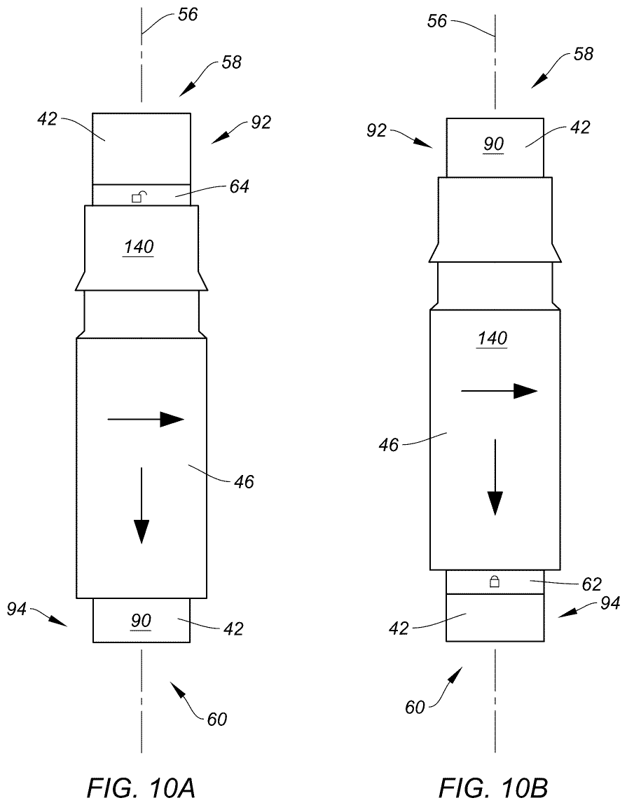

Referring to FIGS. 10A and 10B, in some embodiments, the OC 42 includes a locked indicator 62 and an unlocked indicator 64. In some embodiments, the locked indicator 62 includes a band (e.g., extending at least partially about the circumference) on the OC outer radial surface 90. In some embodiments, the locked indicator 62 is proximal the lock mechanism flange 98. In some embodiments, the unlocked indicator 64 includes a band (e.g., extending at least partially about the circumference) on the OC outer radial surface 90. In some embodiments, the unlocked indicator 64 is proximal the plurality of lock ball apertures 104. In some embodiments, the locked indicator 62 and the unlocked indicator 64 include a respective color (e.g., green for the locked indicator 62, red for the unlocked indicator 64), or a respective icon (e.g., a locked lock for the locked indicator 62, an unlocked lock for the unlocked indicator 64). In embodiments including a locked indicator 62 and an unlocked indicator 64, only one of the indicators (e.g., when the HOR 36 is fully-assembled) is viewable at a time. For instance, the locked indicator 62 is viewable when the HOR 36 is in a locked configuration, and also in a locked and loaded configuration. For instance, the unlocked indicator 64 is viewable when the HOR 36 is in an unlocked configuration.

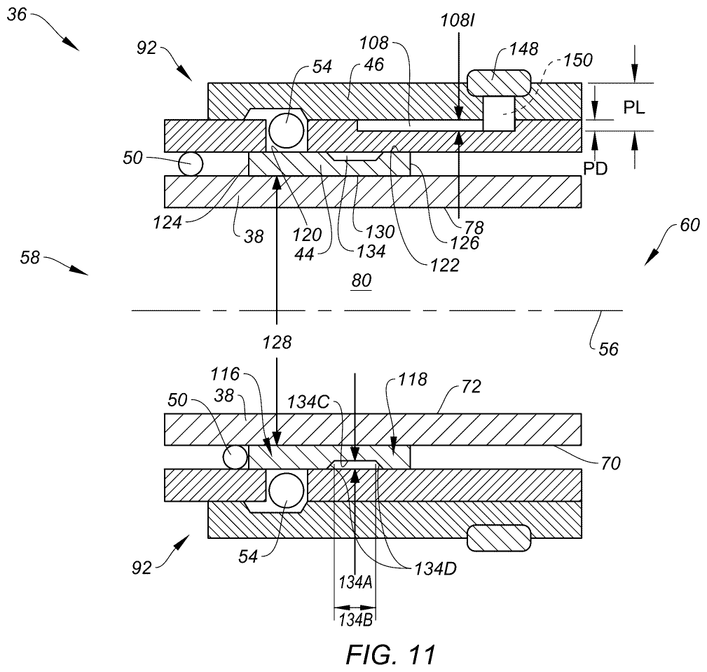

Referring to FIGS. 4 and 11, the retention sleeve 44 (RS) has a RS first axial end 116, a RS second axial end 118, a first RS outer surface 120 (e.g., first RS outer radial surface), a second RS outer surface 122 (e.g., second RS outer radial surface), a first RS end surface 124, a second RS end surface 126, and an RS bore 128 defined by an inner RS surface 130 (e.g., inner RS radial surface). The first RS outer surface 120 extends axially from the RS second axial end 118 to the second RS outer surface 122, the second RS outer surface 122 extends axially from the first RS outer surface 120 to the RS first axial end 116. The first RS end surface 124 extends between the first RS outer surface 120 and the RS inner surface 130. The second RS end surface 126 extends between the second RS outer surface 122 and the RS inner surface 130.

The RS inner surface 130 defining the RS bore 128 is in engagement with the piston outer surface 70 such that the RS bore 128 and the piston outer surface 70 have relative movement (e.g. sliding, translation, etc.) and engage telescopically. Such relative movement of the piston 38 within the RS bore 128 includes the piston 38 telescopically travelling between unlocked and locked configurations, as described in greater detail below. The RS second axial end 118 is (at times during use of the HOR 36) in engagement with the piston head 40 (e.g., when the HOR 36 is in a locked configuration), and will be discussed in greater detail below.

The first RS outer radial surface 120 and the second RS outer radial surface 122 are in engagement with the OC 42 and undergo relative movement (e.g., sliding, translation, configured for telescoping, etc.) with the OC 42 as described in greater detail below.

The RS channel 134 has a depth 134A, a width 134B, and a base surface 134C disposed between a pair of ramp surfaces 134D. The first RS channel 134 is configured to receive at least a portion of a lock ball 54 (e.g., that is arcuate, spherical, etc.) as will be detailed further herein.

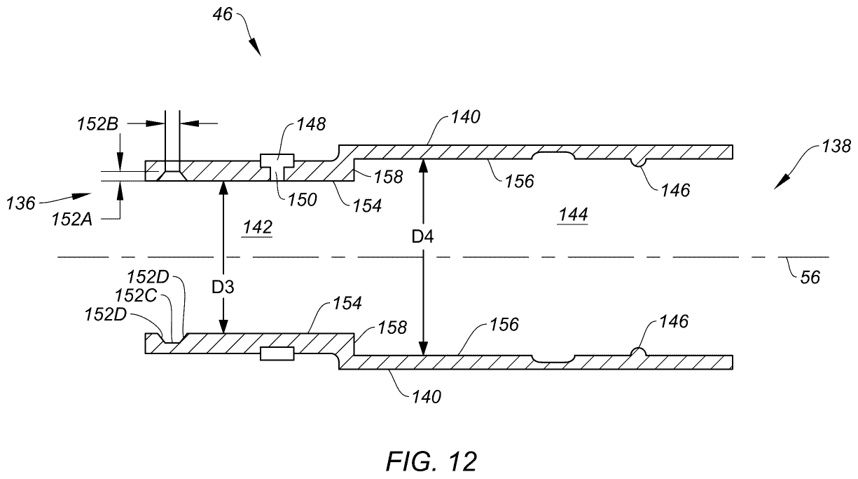

Referring to FIGS. 4 and 12, the lock sleeve 46 (LS) includes a LS first axial end 136, a LS second axial end 138, a LS outer surface 140 (e.g., LS outer radial surface), a first LS cavity section 142, a second LS cavity section 144, a detent 146, a slot 150, and a LS channel 152 that extends circumferentially about the lock sleeve 46 and is around (e.g., radially outward of) the OC 42. The LS first and second axial ends 136, 138 are opposite one another. The first LS cavity section 142 has a diameter D3 and is defined by a first LS inner radial surface 154. The second LS cavity section 144 has a diameter D4 and is defined by a second LS inner radial surface 156. The first LS cavity section 142 diameter D3 is less than the second LS cavity section 144 diameter D4 (D3<D4). The first LS cavity section 142 extends from the LS second axial end 138 to the second LS cavity section 144 and the second LS cavity section 144 extends from the LS first axial end 136 to the first LS cavity section 142. A LS shoulder surface 158 extends radially between the first LS inner radial surface 154 and the second LS inner radial surface 156. The LS channel 152 has a depth 152A, a width 152B, and a base surface 152C disposed between a pair of ramp surfaces 152D. In some embodiments, the lock sleeve 46 may include a circumferentially extending OC retainer bore 112 disposed at the LS first axial end 136, extending inwardly at the intersection of the second LS inner radial surface 156 and the LS first axial end 136.

Referring now to FIG. 11, At least one pin 148 engages a respective slot 150 in the retention sleeve 44. The pin 148 extends through the slot 150 and into the second LS cavity section 144 a distance (“PD”) beyond the second LS inner radial surface 156 for engagement with the pin guide slot 108 as will be detailed herein. The pin 148 has a length (“PL”) less than or equal to the sum of the length of the slot 150 and the depth 1081 of the guide slot 108. The pin 148 has a length PL that is greater than the depth 1081 of the slot 108. The pin 148 is mechanically engaged with the lock sleeve 46 and the OC 42 as contemplated herein. In some embodiments, the pin 148 is coupled to the lock sleeve 46.

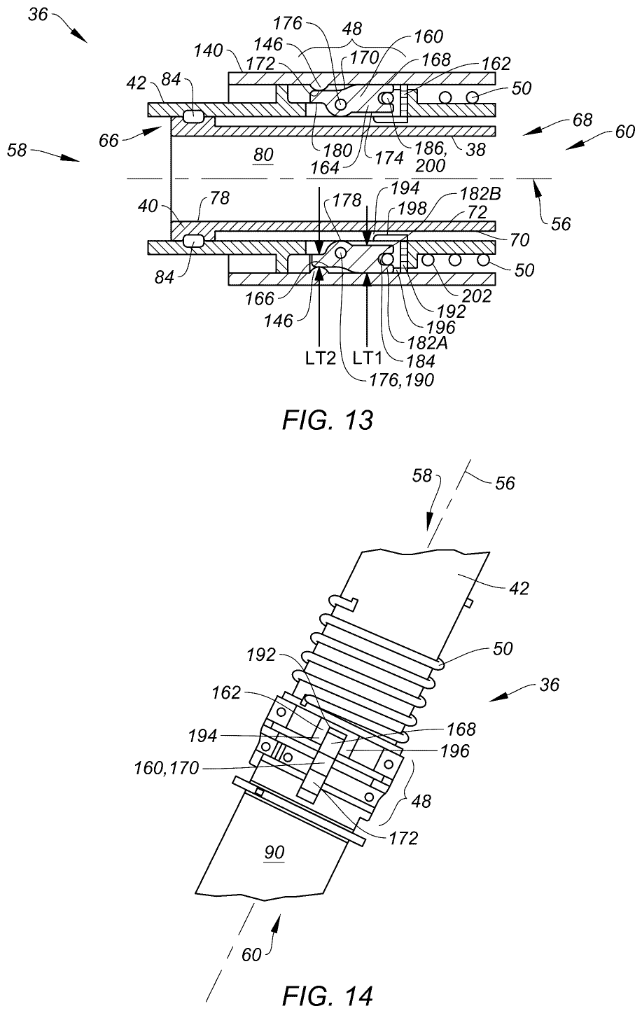

Referring now to FIGS. 13-16, the lock mechanism 48 includes an actuating link (“AL”) 160 and a lock segment 162. The actuating link 160 includes a first link end, 164 a second link end 166, first link surface 168, a sloped surface 170, a second link surface 172, a first inner surface 174, a pivot point 176, a pivot surface 178, a second inner surface 180, a pair of extensions 182 forming a recess 184 therebetween, and a retaining pin 186. The first link end 164 is generally opposite the second link end 166. The first link end 164 includes the first link surface 168 and the first inner surface 174. The second link end 166 includes the second link surface 172 and the second inner surface 180. The first link end 164 has a first end thickness TL1 between the first link surface 168 and the first inner surface 174 that is different than a second end thickness TL2 at the second link end 166 between the second link surface 172 and the second inner surface 180. The first end thickness TL1 is greater than the second end thickness TL2 (TL1>TL2).

The first link surface 168 is adjacent to and coupled with the sloped surface 170. The sloped surface 170 is adjacent to and coupled with the second link surface 172. The first link surface 168 is offset from the second link surface 172 by way of the sloped surface 170. The pivot point 176 enables movement (e.g., pivotal, rotational, etc.) by the actuating link 160 upon application of an external force (e.g., by lock sleeve 46 and/or detent 146) on the first link surface 168, the sloped surface 170, and the second link surface 172. A pivot surface 178 is positioned between the first inner surface 174 and the second inner surface 180. The pivot surface 178 is generally opposite to (e.g., radially opposite to) or radially inward from the sloped surface 170.

The actuating link 160 moves (e.g. pivots, rotates, etc.) about the pivot point 176 from a first position to a second position, where the first position coincides with the unlocked configuration, and the second position coincides with the locked configuration (and also the locked and loaded configuration). The pivot point 176 is configured as a fulcrum when an external force (e.g., the lock sleeve 46 and/or the detent 146) is applied to (e.g., contacts) the first link surface 168, the sloped surface 170, or the second link surface 172. In some embodiments, the pivot point 176 includes a bore 188 configured to receive a pivot point pin 190. In such embodiments, the pivot point pin 190 extends from and is coupled to the OC 42. Other embodiments include other connecting features such as outwardly extending bosses from the pivot point 190 that engage the OC 42.

The first link end 164 includes a pair of extensions 182. The pair of extensions 182 form a recess 184 therebetween. The pair of extensions 182 are generally parallel to each other about the axial length, where one of the extensions 182A is radially outward (or inward) of the other extension 182B.

The lock segment 162 includes a first segment end 192 and a second segment end 194, an outward arm 196 and an inward arm 198. The outward arm 196 and the inward arm 198 are between the first segment end 192 and the second segment end 194. The lock segment 162 includes a central protrusion 200 such as a pin attached thereto by known means (e.g., brazing, welding, mechanical or chemical fastening, etc.). The central protrusion 200 may include retaining pin 186 and is positioned between the pair of extensions and is mechanically engaged with the pair of extensions. The outward arm is radially outward of the actuation link. The inward arm is radially inward of the actuation link.

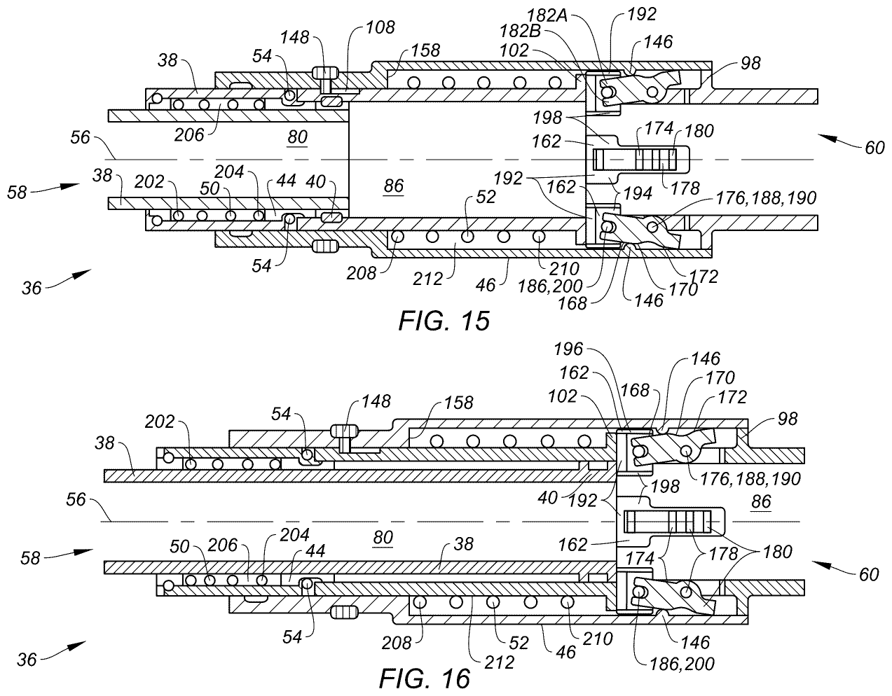

Referring to FIGS. 4 and 15-16, the lock spring 50 has a first lock end 202 and a second lock end 204. The lock spring 50 is disposed in an annular region 206 axially between the retention sleeve 44 and the OC retainer 114. The lock spring 50 is disposed in an LS annular region 206 radially between the piston 38 and the outer cylinder 42. The first lock end 202 is mechanically engaged with the OC retainer 114. The second lock end 204 is mechanically engaged with the RS first axial end 116. In the FIGURES, the lock spring 50 is shown as a helical spring (e.g., torsional spring) and is configured to resist axial movement of the retention sleeve 44 toward the HOR first axial end 58 and to bias the retention sleeve 44 in the opposite direction toward the HOR second axial end 60. The present disclosure is not limited to any particular lock spring 50 configuration. In FIG. 4 wherein the HOR 36 is in an unlocked configuration, the lock spring 50 is in a substantially uncompressed state. In FIG. 15 where the HOR 36 is in a locked configuration, and in FIG. 16 where the HOR 36 is in a locked and loaded configuration, the lock spring 50 is in a compressed state.

The release spring 52 includes a first release end 208 and a second release end 210. The release spring 52 is disposed in a RS annular region 212 radially between the OC outer radial surface 90 and the first LS inner radial surface 154. The release spring 52 is disposed axially between the LS shoulder 155 and the release spring flange 102. The release spring first end is mechanically engaged with the LS shoulder surface 158. The release spring second end is mechanically engaged with the release spring flange 102. In the FIGURES, the release spring 52 is shown as a helical (e.g., torsional) spring and is configured to bias the lock sleeve 46 toward the HOR first axial end 58 and to resist movement of the lock sleeve 46 in the opposite direction. The present disclosure is not limited to any particular release spring 52 configuration. In FIG. 4, where the HOR 36 is in an unlocked configuration, the release spring 52 is in a compressed state. When the HOR 36 is in a locked configuration in FIG. 15, and when the HOR 36 is in the locked and loaded configuration in FIG. 16, the release spring 52 is in an uncompressed state.

FIG. 4 illustrates a present disclosure HOR 36 embodiment disposed in an “unlocked” configuration. FIG. 3 illustrates a fan cowl member 28A disposed in a stowed condition. When the fan cowl member 28A is in a stowed condition, the HOR 36 is in an unlocked configuration. In the unlocked configuration, the piston head 40 is mounted within the OC inner cavity 86 proximate the HOR second axial end 60, and the retention sleeve 44 is mounted within the OC inner cavity 86 proximate the HOR first axial end 58. In this position, the retention sleeve 44 is prevented from (e.g., by being mechanically engaged with the lock spring 50 second lock end 204) traveling axially toward the HOR second axial end 60 by the OC retainer 114 that is at least partially received within the OC retainer bore 112 disposed in the OC first axial end wall 96. In the unlocked configuration, the lock sleeve 46 is prevented from traveling axially by the plurality of lock balls 54 each disposed partially in a respective of the plurality of the lock ball apertures 104 disposed in the OC 42 and partially into the LS channel 152. In the HOR 36 embodiment shown in the FIGURES, the LS channel 152 includes an axial width 152B that is greater than the diameter of a respective of the plurality of lock balls 54; e.g., to facilitate alignment. In the unlocked configuration, the lock spring 50 is substantially unloaded and the release spring 52 is compressed (e.g., under compression).

Referring to FIGS. 8-9, in the unlocked configuration, the pin 148 is received in the axially extending guide portion 108C at the PG second axial end 108B of the pin guide slot 108. Referring to FIG. 4, the detent 146 is engaged on the second link surface 172. In the unlocked configuration, the unlocked indicator 64 is visible when viewing the HOR 36.

FIGS. 4 and 15-16 illustrate relative movement of HOR 36 components as the HOR 36 transitions from an unlocked configuration to a locked configuration and thereafter a locked and loaded configuration.

Referring to FIGS. 4 and 15, the piston 38 is moved axially in a direction from the HOR second axial end 60 toward the HOR first axial end 58 in the process of transitioning from the unlocked configuration to a locked and loaded configuration. The fan cowl member 28A (see FIGS. 3-3B) is attached to the HOR first axial end (e.g., cowl end) 58 of the HOR 36 and as the fan cowl member 28A is moved (e.g., pivoted, rotated, etc.) outwardly, the piston 38 is drawn in the direction from the HOR second axial end 60 toward the HOR first axial end 58; e.g., the HOR 36 is extending, expanding, elongating, etc. As can be seen in FIGS. 4 and 15, the piston head 40 moves axially with the piston 38. FIG. 15 shows the piston head 40 engaged with the RS second axial end 118 of the retention sleeve 44 and moves the retention sleeve 44 axially (e.g., towards the HOR first axial end 58). The LS second axial end 138 is spaced apart from the OC first axial end wall 96, the lock spring 50 is relaxed (e.g., under a lower amount of compressive force than in the unlocked configuration), and the release spring 52 is in compression.

The RS channel 134 is now aligned with the plurality of lock ball apertures 104 of the OC 42. In this aligned position, the lock sleeve 46 tends to move axially towards the HOR first axial end 58 under the spring force from release spring 52. As a result of the radial force from the ramp 152D of the LS channel 152, each of the plurality of lock balls 54 are pushed radially inward so as to be partially disposed in a respective of the plurality of lock ball apertures 104 of the OC 42 and partially disposed in the RS channel 134. Once each of the plurality of lock balls 54 have left the LS channel 152 and are therefore no longer engaged with the lock sleeve 46, the lock sleeve 46 is free to move axially toward the HOR first axial end 58.

Focusing now on the locking mechanism 48, upon relative movement of the detent 146 and the actuation link 160, the lock mechanism 48 moves radially (e.g., from a radially outward position in the unlocked configuration, to a radially inward position in the locked configuration). The detent 146 moves (e.g., slides, translates, etc.) along the second link surface 172 to the sloped surface 170 and along the first link surface 168. When the detent 146 is positioned along the second link surface 172, the actuation link 160 is in a radially outward configuration. In the radially outward configuration, the lock segment 162 is generally flush with the OC inner radial surface 88. When the detent 146 is positioned along the first link surface 168, the actuation link 160 is in a radially inward configuration. In the radially inward configuration, the lock segment 162 is radially inward of the OC inner radial surface 88.

Upon relative movement of the lock sleeve 46 (e.g., towards the HOR first axial end 58) with respect to the OC 42, the unlocked indicator 64 (e.g., on the OC 42) is covered by the lock sleeve 46 and the locked indicator 62 (e.g., on the OC 42) is uncovered by the lock sleeve 46.

Focusing now on the mechanical engagement of the pin 148 and the guide slot 108, to get to the axial position shown in FIGS. 15-16, the pin 148 extending inwardly from the OC inner radial surface 88 and engaged with the pin guide slot 108 of the OC 42 travels axially through the axially extending guide portion 108C of the pin guide slot 108 (see FIGS. 8-9) from the PG second axial end 108B to an intermediate position 108E proximate the interface between the axially extending guide portion 108C (and, for embodiments with ramp portion 108D, the guide ramp surface 108F). In embodiments with ramp portion 108D, once the pin 148 engages the ramp portion 108D, further axial travel of the pin 148 along the guide ramp surface 108F will cause the lock sleeve 46 to rotate relative to the OC 42 (e.g., in an amount approximately equal to the circumferential travel distance “C1”) as it travels axially. In embodiments without ramp portion 108D, the lock sleeve 46 continues to travel radially (e.g. in an amount equal to C1) until the pin 148 arrives at the PG first axial end 108A-labeled as the “locked” position. When the lock sleeve 46 has traveled sufficiently for the pin 148 to be disposed in the “locked” position, the LS channel 152 is no longer aligned with each of the plurality of lock ball apertures 104 within the OC 42, and each of the plurality of lock balls 54 are captured by a respective one of the plurality lock ball apertures 104 of the OC 42 and the RS channel 134. In this position, the piston head 40 is “locked” to the OC 42 by way of the retention sleeve 44. The piston 38 position shown in FIG. 15 may be referred to as the “locked” position which reflects the maximum rotational travel of the fan cowl member 28A attached to the HOR 36; e.g., see FIG. 3B. In the HOR 36 locked position, the OC retainer 114 is engaged with the OC retainer bore 112 disposed in the lock sleeve 46 to limit the travel of the lock sleeve 46 relative to the OC 42.

Referring to FIGS. 15-16, the piston 38 is moved axially downward from the HOR first axial end 58 in the direction towards the HOR second axial end 60. The lock segment 162 remains in the radially inward configuration (e.g., the lock sleeve detent 146 is mechanically engaged with the first link surface 168), such that the lock segment 162 is radially inward of the OC inner radial surface 88. The lock segment 162 in this radially inward position prevents axial movement of the piston head 40 (and also the piston 38 coupled to the piston head 40) as the lock segment 162 becomes a stop surface for the piston head 40. In this position, the lock spring 50 is now relaxed, and the release spring 52 is also relaxed as the lock segment 162 carries the load. Also in this position, each of the plurality of lock balls 54 are partially disposed in a respective one of the plurality of lock ball apertures 104 and partially disposed in the RS channel 134, thereby preventing axial movement of the retention sleeve 44.

In this position, the locked indicator 62 (e.g., on the outer cylinder 42) remains uncovered by the lock sleeve 46.

FIG. 16 diagrammatically illustrates the HOR 36 in a “locked and loaded” configuration. To get to the locked and loaded configuration, the fan cowl member 28A is allowed to rotate some small amount back towards its stowed condition (albeit far from its stowed condition). This reverse movement causes the piston 38 to reverse the earlier described axial movement toward the HOR first axial end 58 and now moves toward the HOR second axial end 60; i.e., HOR 36 contracting. In this locked and loaded configuration, the pin 148 remains in the same position (i.e., first axial end 108A as shown in FIGS. 8-9) even when loaded because no load is passed to the lock sleeve 46 and the pin 148 is connected to the lock sleeve 46 which stays in same position.

To return the fan cowl member 28A to a stowed configuration and the HOR 36 to an unlocked configuration, the fan cowl member 28A is rotated back towards its maximum open condition (e.g., see FIG. 3B) and the HOR 36 extended, expanded, elongated, etc. In this manner, the HOR 36 becomes “unloaded”. To transition the HOR 36 from the locked and loaded configuration to the unlocked configuration, the lock sleeve 46 must be moved (e.g., rotated, translated, slid, pivoted, etc.) radially so that the pin 148 moves approximately the distance C1. In embodiments including a ramp portion 108d, the lock sleeve 46 moves radially so that the pin 148 is proximate to the guide ramp surface 108F of the ramp portion 108D of the pin guide slot 108. Failure to radially moved (e.g., rotate, translate, slide, pivot, etc.) the lock sleeve 46 will result in the pin 148 contacting the base surface 108H of the ramp portion 108D and the base surface 108H will prevent any further axial travel of the pin 148/HOR piston 38. Hence, the present disclosure HOR 36 requires two actions (i.e., rotation and axial movement of the lock sleeve 46) to transition the HOR 36 to the unlocked configuration.

The lock sleeve 46 is moved (e.g., pushed or pulled) axially downward towards the HOR second axial end 60. The lock sleeve 46 axial movement (e.g., downward, towards the HOR second axial end 60) causes the LS channel 152 to align with each of the plurality of lock ball aperture 104. Each of the plurality of lock ball 54 travels radially outward from the RS channel 134 and the respective lock ball aperture 104 into the LS channel 152 while still partially remaining in the respective lock ball aperture 104. Once each of the plurality of lock balls 54 has moved into the RS channel 134 and cleared the LS channel 152, the piston 38 releases and travel downwardly towards the HOR second axial end 60. The piston head 40 releases the lock spring 50 through the retention sleeve 44 moving both the lock spring 50 and the retention sleeve 44 axially towards the HOR second axial end 60. Said differently, the piston head 40 engages with the RS second axial end 118 of the retention sleeve 44 and moves the retention sleeve 44 axially (e.g., towards the HOR second axial end 60).

When the lock sleeve 46 is moved towards the HOR second axial end 60, the detent 146 moves from the first link surface 168 to the sloped surface 170 and thereafter to the second link surface 172. This movement of the detent 146 causes the actuation link 160 to move (e.g., pivot, rotate) such that the first link end 164 moves radially outward. This radially outward movement brings the lock segment 162 radially outward of the OC inner radial surface 88. Once the lock segment 162 is radially outward of the OC inner radial surface 88, the piston head 40 bypasses the lock segment 162 towards the HOR second axial end 60. The unlocked indicator 64 is now visible. The locked indicator 62 is now concealed (e.g. obfuscated) by the lock sleeve 46.

While the present disclosure often provides embodiments focused on a single feature (e.g., a cowling 28, a HOR 36) it is understood that a plurality of cowlings 28, a plurality of HOR's 36 are within the scope of the present disclosure. To that end, each HOR may include a plurality of lock mechanisms 48 (e.g., two, three, four, etc.). Further, the plurality of lock balls 54 and the respective engaging features on the OC 42, retention sleeve 44, lock sleeve 46, may include two, three, four etc.

The HOR 36 including its constituent components such as the piston 38, the OC 42, the retention sleeve 44, the lock sleeve 46, lock mechanism 48, the lock spring 50, the release spring 52, and the plurality of lock balls 54, may comprise a metal such as aluminum or stainless steel, or a composite material such as carbon fiber reinforced plastic (CFRP). The PH 40 may comprise a material such as metal (e.g., aluminum or stainless steel). A non-limiting example of a bearing 84 that may be used is a sleeve bearing comprising a material such as polyether ether ketone (PEEK). The present disclosure is not, however, limited to these material examples. More particularly, the actuating link may comprise a carbon fiber or plastic material. More particularly, the locking segments 162 are configured to carry the load of the HOR 36, and thus may include a higher strength material than the actuating link 160, such as a metal (e.g., aluminum or stainless steel) or a composite material such as CFRP.

Materials and components contemplated by the present disclosure are, in some embodiments unitary, and in other embodiments, coupled by known means. Coupling means include brazing, welding, mechanical fasteners, chemical bonding, and combinations thereof.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

1. A hold open rod (HOR) having an axial centerline that extends between a HOR first axial end and a HOR second axial end, comprising:
a lock sleeve (LS) having a first axial end and a second axial end generally opposite to the first axial end, a LS outer radial surface and a LS inner radial surface, the LS inner radial surface defining a first LS cavity section and a second LS cavity section, the LS having a slot extending through the LS outer radial surface and the LS inner radial surface, the LS having a LS channel;
a pin having a pin length (PL), the pin engaged with the slot and extending radially inward from the LS inner radial surface;
an outer cylinder (OC) having an OC outer radial surface, an OC inner radial surface defining an OC inner cavity, a plurality of lock ball apertures extending between the OC outer radial surface and the OC inner radial surface, a pin guide slot configured to receive a portion of the pin, wherein the outer cylinder extends axially within the first LS cavity section and the second LS cavity section
a retention sleeve (RS) having a RS first axial end and a RS second axial end, a first RS outer radial surface, a RS channel, a second RS outer radial surface, a RS first end surface, a RS second end surface, an RS inner radial surface defining a RS bore, wherein the RS is disposed within the OC inner cavity;
a piston having a piston outer radial surface and a piston head (PH), the piston head having a PH outer radial surface coaxial with the piston outer radial surface, the piston and the piston head are disposed within OC inner cavity;
a plurality of lock balls, each configured to pass through a respective lock ball aperture;
a release spring disposed between the OC outer radial surface and the LS inner radial surface;
a lock mechanism comprising:
an actuation link having a first link end and a second link end generally opposite the first link end, a first link surface adjacent a sloped surface, the sloped surface is adjacent a second link surface, the first link surface is offset from the second link surface, the actuation link having a pivot point, the actuation link having a pair of extensions defining a channel therebetween; and
a lock segment having a first lock end and a second lock end generally opposite the first lock end, a central protrusion between the first lock end and the second lock end that engages the channel; and
a release spring disposed between the OC outer radial surface and the LS inner radial surface; and
a lock spring disposed between the OC inner radial surface and the piston outer radial surface.

2. The hold open rod of claim 1, wherein the hold open rod is configurable in an unlocked configuration, wherein in the unlocked configuration, each respective one of the plurality of lock balls extends within each respective one of the plurality of lock ball apertures and the LS channel.

3. The hold open rod of claim 2, wherein the hold open rod is configurable in a locked configuration, wherein in the locked configuration each respective one of the plurality of lock balls extends within each respective one of the plurality of lock ball apertures and the RS channel.

4. The hold open rod of claim 3, wherein the RS channel extends between the first RS outer radial surface and the second RS outer radial surface, and includes a RS base surface disposed between a pair of RS ramp surfaces.

5. The hold open rod of claim 4, wherein the LS channel extends around a circumference of the first LS cavity section and includes a base surface disposed between a pair of LS ramp surfaces.

6. The hold open rod of claim 5, wherein in a transition from the unlocked configuration to the locked configuration, the lock sleeve is configured to translate axially relative to the outer cylinder in a direction toward the first axial end and one of the LS ramp surfaces pushes each respective lock ball radially inward.

7. The hold open rod of claim 6, wherein in the locked configuration, each respective lock ball extends within a respective said lock ball aperture and the RS channel.

8. The hold open rod of claim 7, wherein the RS channel extends between the first RS outer radial surface and the second RS outer radial surface, and includes a RS base surface disposed between a pair of RS ramp surfaces.

9. The hold open rod of claim 8, wherein in a transition from the locked configuration to the unlocked configuration, the lock sleeve is configured to translate downwardly towards the second axial end causing a detent extending radially inwardly from the LS inner radial surface to translate from the first link end to the second link end thereby (i) pivoting the lock segment radially outward of the OC inner radial surface, and (ii) aligning the LS channel with the plurality of lock ball apertures and the RS channel causing one of the RS ramp surfaces to push each respective lock ball radially outward from the RS channel through the respective lock ball aperture and into the respective LS channel, and the piston head is configured to translate axially relative to the outer cylinder in a direction toward the second axial end bypassing the lock segment.

10. The hold open rod of claim 9, wherein the piston head further includes a bearing disposed in a PH channel disposed on the PH outer radial surface.

11. The hold open rod of claim 10, wherein the pin guide slot is configured such that a transition from the locked configuration to the unlocked configuration requires the lock sleeve to be translated both axially and rotationally relative to the outer cylinder.

12. The hold open rod of claim 11, wherein the pin guide slot has a first axial end, an intermediate position a second axial end;
wherein the first axial end is aligned axially with the intermediate position; and
wherein the intermediate position is aligned radially with the second axial end.

13. The hold open rod of claim 12, wherein the release spring is axially disposed between an OC shoulder and a release spring flange extending outwardly from the outer cylinder.

14. The hold open rod of claim 13, wherein the hold open rod is configurable in an unlocked configuration and a locked configuration; and
wherein in the locked configuration, a second RS end surface is disposed contiguous with the piston head.

15. The hold open rod of claim 1, wherein the hold open rod is configurable in a locked and loaded configuration, and in the locked and loaded configuration, the lock segment is radially inward of the OC inner radial surface.

16. The hold open rod of claim 1, wherein the outer cylinder includes a release spring flange extending radially outward from the OC outer radial surface;
wherein the lock sleeve further includes a LS shoulder surface extending between a first LS inner radial surface and a second LS inner radial surface; and
wherein the release spring is axially disposed between the release spring flange and the LS shoulder surface.

17. The hold open rod of claim 1,
wherein in a first transition from the unlocked configuration to the locked configuration, the piston head is configured to translate axially relative to the outer cylinder towards the HOR first axial end until the piston head engages the RS second axial end thereby compressing the lock spring until the RS channel is aligned with the plurality of lock ball apertures;
wherein the lock sleeve is configured to translate axially and rotationally relative to the outer cylinder, and each respective one of the plurality of lock balls is moved radially inward to extend within each respective one of said plurality of lock ball aperture and the first RS channel.

18. The hold open rod of claim 17,
wherein in a second transition from the locked configuration to the unlocked configuration, the lock sleeve is configured to translate rotationally and axially relative to the outer cylinder;
wherein the axial translation is in a direction toward the HOR second axial end until the LS channel is aligned with the lock ball apertures and each respective lock ball is moved radially outward to extend within the respective said lock ball aperture and the LS channel; and
wherein the piston head is configured to translate axially relative to the outer cylinder in a direction toward the second axial end.

19. A hold open rod (HOR) having an axial centerline that extends between a HOR first axial end and a HOR second axial end, comprising:
a lock sleeve (LS) having a first axial end and a second axial end generally opposite to the first axial end, a LS outer radial surface and an LS inner radial surface, the LS inner radial surface defining a first LS cavity section and a second LS cavity section;
an outer cylinder (OC) having an OC outer radial surface, an OC inner radial surface defining an OC inner cavity;
a retention sleeve (RS) having a RS first axial end and a RS second axial end, a first RS outer radial surface, a RS first end surface, a RS second end surface, an RS inner radial surface defining a RS bore, wherein the RS is disposed within the OC inner cavity;
a piston having a piston outer radial surface and a piston head (PH), the piston head having a PH outer radial surface coaxial with the piston outer radial surface, the piston and the piston head are disposed within OC inner cavity;
a lock mechanism comprising:
an actuation link having a first link end and a second link end generally opposite the first link end, a first link surface adjacent a sloped surface, the sloped surface is adjacent a second link surface, the first link surface is offset from the second link surface, the actuation link having a pivot point, the actuation link having a pair of extensions defining a channel therebetween; and
a lock segment having a first lock end and a second lock end generally opposite the first lock end, a central protrusion between the first lock end and the second lock end that engages the channel; and
a release spring disposed between the OC outer radial surface and the LS inner radial surface; and
a lock spring disposed between the OC inner radial surface and the piston outer radial surface.

20. A hold open rod (HOR) having an axial centerline that extends between a HOR first axial end and a HOR second axial end, comprising:
a lock sleeve (LS) having a first axial end and a second axial end generally opposite to the first axial end, a LS outer radial surface and a LS inner radial surface, the LS inner radial surface defining a first LS cavity section and a second LS cavity section, the LS having a LS channel;
an outer cylinder (OC) having an OC outer radial surface, an OC inner radial surface defining an OC inner cavity, a plurality of lock ball apertures extending between the OC outer radial surface and the OC inner radial surface; wherein the outer cylinder extends axially within the first LS cavity section and the second LS cavity section
a retention sleeve (RS) having a RS first axial end and a RS second axial end, a first RS outer radial surface, a RS channel, a second RS outer radial surface, a RS first end surface, a RS second end surface, an RS inner radial surface defining a RS bore, wherein the RS is disposed within the OC inner cavity;
a piston having a piston outer radial surface and a piston head (PH), the piston head having a PH outer radial surface coaxial with the piston outer radial surface, the piston and the piston head are disposed within OC inner cavity;
a plurality of lock balls, each configured to pass through a respective lock ball aperture;
a release spring disposed between the OC outer radial surface and the LS inner radial surface; and
a release spring disposed between the OC outer radial surface and the LS inner radial surface; and
a lock spring disposed between the OC inner radial surface and the piston outer radial surface.
